(19) United States
(12) Patent Application Publication
(10) Pub. No.: US 2010/0136417 A1
(43) Pub. Date: Jun. 3, 2010

(54) BATTERY COVER LATCH ASSEMBLY

(75) Inventors: MU-WEN YANG, Shindian (TW); CHIH-CHIANG CHANG, Shindian (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/578,154

(22) Filed: Oct. 13, 2009

(30) Foreign Application Priority Data
Nov. 28, 2008 (CN) 200810305864.9

(51) Int. Cl. H01M 2/04

(52) U.S. Cl. 429/163

(57) ABSTRACT

A battery cover latch assembly comprised a battery housing member and a battery cover. The battery housing member includes a first sidewall and a second sidewall opposite to the second sidewall. The battery housing member has two first guiding grooves and two first guiding poles. The first guiding grooves are respectively defined in the first sidewall and the second sidewall. The first guiding poles are respectively protruding from the first sidewall and the second sidewall. The battery cover includes two opposite sliding plates, each sliding plate hays a second guiding groove defined therein and a second guiding pole protruding therefrom. The first guiding poles are slidably accommodated in the second guiding grooves, the second guiding poles are slidably accommodated in the first guiding grooves, such that the battery cover is slidably mounted to the battery housing member.

### BACKGROUND

1. Technical Field

The exemplary disclosure generally relates to battery cover latch assemblies, particularly to a battery cover latch assemblies used in portable electronic devices.

2. Description of Related Art

As a power source, batteries are widely used in portable electronic devices, such as personal digital assistants (PDAs), cellular phones and etc. Conventional batteries are received in the electronic devices, and battery covers are designed to engage with housings of the electronic devices to package the batteries. When the battery need to be replaced, the cover is removed and disengaged from the housing of the portable electronic device.

A clasp structure or latch structure is used with a conventional battery cover to engage with a housing of a portable electronic device. For example, a latch comprises a pair of hooks at one end of the battery cover and a locking pin protruding at the other end of the battery cover. Accordingly, a pair of troughs is defined in an end portion of a backside of a housing of the cellular phone, and a locking hole is defined in the other end portion of the backside of the housing. In assembly, the hooks are firstly inserted into the troughs in the backside of the housing. Then, the battery cover is pressed downwardly to the housing until the locking pin on the battery cover is inserted into the locking hole in the backside of the housing. The battery cover is thus assembled to the housing of the cellular phone. However, during disassembly, the battery cover is susceptible to being damaged, since a great force is exerted thereon. As a result, it is inconvenient for a user to change a battery in the housing of the cellular phone.

Therefore, there is a room for improved in the arts.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary battery cover latch assembly. Moreover, in the drawings like reference numerals designate corresponding parts throughout the several views. Wherever possible, the same reference numbers are used throughout the drawings to refer to the same or like elements of an embodiment.

FIG. 1 is an exploded view of an exemplary embodiment of a battery cover latch assembly including a battery housing member and a battery cover.

FIG. 2 is a partially cut-away view of the battery cover latch assembly shown in FIG. 1 in which the battery cover latch assembly is assembled.

FIG. 3 is similar to FIG. 2, but the battery cover is in an opened state.

### DETAILED DESCRIPTION OF THE EMBODIMENTS

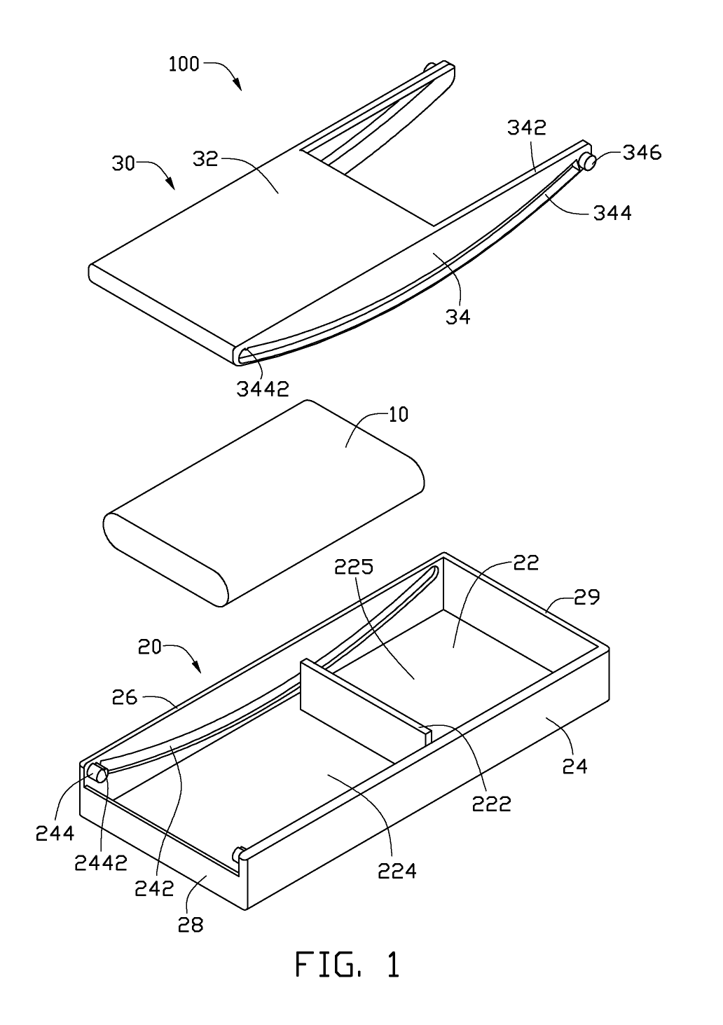

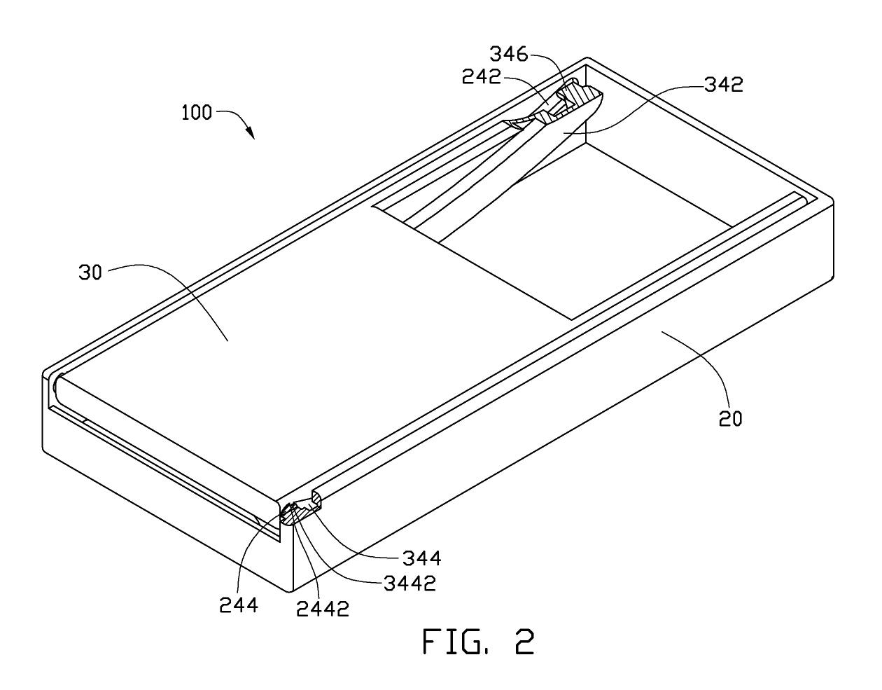

Referring to FIGS. 1 and 2, an exemplary battery cover latch assembly 100 used in a portable electronic device for accommodating a battery 10 is shown. The battery cover latch assembly 100 is structured by a portion of battery housing member 20 and a portion of a second battery housing or battery cover 30. The battery cover 30 is slidably mounted to the battery housing member 20.

The battery housing member 20 includes a bottom wall 22 and a plurality of sidewalls protruding from an edge portion of the bottom wall 22. The sidewalls includes a first sidewall 24, a second sidewall 26 opposite to the first sidewall 24, a third sidewall 28 connecting the first sidewall 24 with the second sidewall 26 and a fourth sidewall 29 opposite the third sidewall 28. The battery housing member 20 further has a partition plate 222 formed between the third sidewall 28 and the fourth sidewall 29, so a firsat compartment 224 is defined by the first sidewall 24, the second sidewall 26, the third sidewall 28 and the partition plate 222. A second compartment 225 is defined by first sidewall 24, the second sidewall, the fourth sidewall 29, and partition 222. The first compartment 224 is used for accommodating the battery 10. The second compartment 225 is used for accommodating the electronic circuitry of the portable electronic device and includes a cover (not shown) for protecting the circuitry.

The battery housing member 20 has two first guiding grooves 242 respectively defined in the first sidewall 24 and the second sidewall 26, and the first guiding grooves 242 are symmetrical to each other. One end of each first guiding groove 242 is located adjacent to the third sidewall 28, another end of each first guiding groove 242 is located adjacent to fourth sidewall 29. The shape of the first guiding grooves 242 is substantially arcuate, however, other shape can be substituted. The battery housing member 20 further has two first guiding poles 244 respectively protruding from the first sidewall 24 and the second sidewall 26. The first guiding poles 244 are defined between the third sidewall 28 and the first guiding grooves 242. Each guiding pole 244 has a first latching portion in the form of a slot 2442 defined therein. The first latching portion is configured to latch with the battery cover 30.

The battery cover 30 includes a cover plate 32 and two sliding plates 34 situated at two opposite edge of the cover plate 32. The sliding plates 34 extend outwardly from one end of the cover plate 32, and two opposite cantilever plates 342 are defined on the battery cover 30. The cantilever plates 342 are configured to facilitate mounting the cover plate 32 to the battery housing member 20, and the rational will be described afterherein.

Each sliding plate 34 has a second guiding groove 344 defined in an outer surface thereof. The second guiding grooves 344 have the same shape and size as the first guiding grooves 242. The first guiding poles 244 are slidably accommodated in the second guiding grooves 344, correspondingly. Each sliding plate 34 further includes a second latching portion in the form of a protrusion 3442 protruding from an inner surface of the second guiding groove 344. The second latching portions are latched with the first latching portions. Each cantilever plate 342 has a second guiding pole 346 protruding from a distal end thereof corresponding to the first guiding grooves 242. The second guiding poles 346 are slidably accommodated in the first guiding grooves 242, correspondingly.

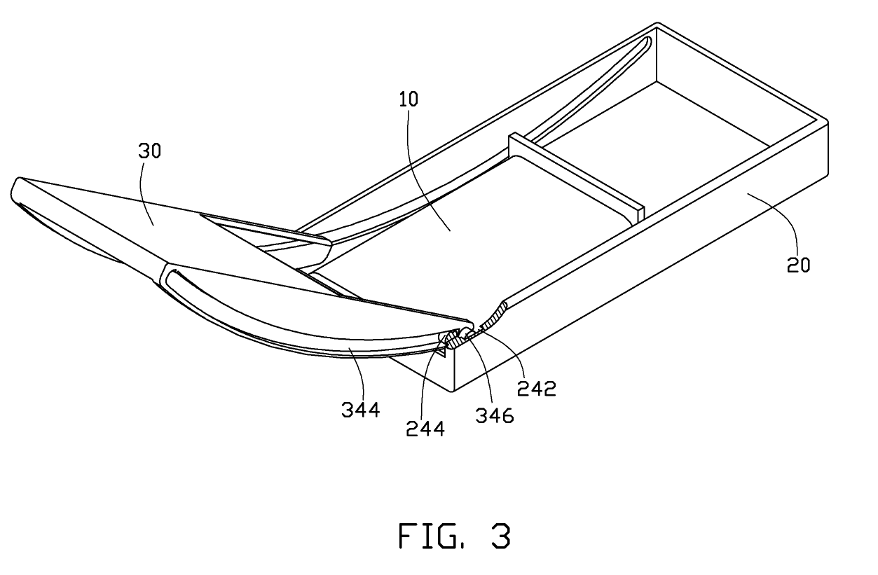

Referring to FIG. 3, during assembling the battery cover latch assembly 100, firstly, the cantilever plates 342 are bent toward each other to decrease the distance therebetween, so the cantilever plates 342 are easily inserted between the first sidewall 24 and the second sidewall 26. Secondly, the first guiding poles 244 and the second guiding poles 346 are correspondingly aligned with the second guiding grooves 344 and the first guiding grooves 242.

Then, the cantilever plates 342 are released to expand such that the first guiding poles 244 and the second guiding poles 346 are inserted into the second guiding grooves 344 and first guiding grooves 242, correspondingly. After that, the battery cover 30 is pushed so that the first guiding poles 244 and the second guiding grooves 344 are respectively slid in the second guiding grooves 344 and the first guiding grooves 242, until the battery cover 30 covers the compartment 224 of the battery housing member 20. At this time, the first latching portions are latched with the second latching portions in such a manner that the slots 2442 of the first guiding poles 244 accommodate the protrusions 3442 in the second guiding grooves 344. Thus, the battery cover 30 is firmly mounted to the battery housing member 20, i.e., the battery cover 30 is in a closed position shown in FIG. 2.

When removing the battery 10 out of the compartment 224, the battery cover 30 is reversely pulled so that the protrusions 3442 can slide out of the slots 2442. At this time, the latching engagement between the battery cover 30 and the battery housing member 20 is released. The battery cover 30 is continuously pulled until the compartment 224 is exposed again as shown in FIG. 3, where the battery 10 can be removed from the compartment 224.

It is understood that the slots of the first guiding poles 244 and the protrusions 3442 may be replaced by other orientation mechanism. For instance, an end portion of each second guiding groove 344 for accommodating the first guiding poles 244 are slightly smaller than the first guiding poles 244, so that the first guiding poles 244 are securely accommodated in the end potions of the second guiding grooves 344. Also, the first guiding poles 244 and the second guiding grooves 344 may be omitted.

In the present embodiment, a guiding mechanism that includes the first guiding groove 242, the second poles 346, the second guiding grooves 344, and the first guiding poles 244 is provided such that the battery cover 30 can slide relative to the battery housing member 20 to cover/expose the compartment 224 so as to assemble/disassemble the battery 10.

It is to be understood, however, that even through numerous characteristics and advantages of the exemplary invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latch assembly, comprising:
a battery housing member, the battery housing member including a first sidewall and a second sidewall opposite to the second sidewall, the battery housing member having two first guiding grooves and two first guiding poles, the first guiding grooves respectively defined in the first sidewall and the second sidewall, the first guiding poles respectively protruding from the first sidewall and the second sidewall; and
a battery cover, the battery cover including two opposite sliding plates, each sliding plate having a second guiding groove defined therein and a second guiding pole protruding therefrom; and
wherein the first guiding poles are slidably accommodated in the second guiding grooves, the second guiding poles are slidably accommodated in the first guiding grooves, such that the battery cover is slidably mounted to the battery housing member.

2. The battery cover latch assembly as claimed in claim 1, wherein each first guiding pole has a first latching portion formed thereon, each sliding plate has a second latching portion formed on an inner surface in the second guiding groove, the first latching portions are latched with the second latching portion to firmly mount the battery cover to the battery housing member.

3. The battery cover latch assembly as claimed in claim 2, wherein each first latching portion is a slot defined in the first guiding pole, each second latching portion is a protrusion protruding from the inner surface in the second guiding groove, the protrusions are accommodated in the slots to firmly mount the battery cover to the battery housing member.

4. The battery cover latch assembly as claimed in claim 1, wherein the battery housing assembly further includes a third sidewall connecting the first sidewall with the second sidewall, the first guiding poles are located between the first third sidewall and the first guiding grooves.

5. The battery cover latch assembly as claimed in claim 4, wherein the battery housing member further includes a fourth sidewall, the first guiding grooves extend from the third sidewall to the fourth sidewall.

6. The battery cover latch assembly as claimed in claim 5, wherein the extending path of each first guiding groove is arcuate.

7. The battery cover latch assembly as claimed in claim 6, wherein the second guiding grooves have the same shape and size as the first guiding grooves.

8. The battery cover latch assembly as claimed in claim 1, wherein the battery cover further includes a cover plate, the sliding plates protrude from two opposite edge of the cover plate.

9. The battery cover latch assembly as claimed in claim 8, wherein the sliding plates extend outwardly from one end of the cover plate, so two opposite cantilever plates are formed on battery cover, the second guiding poles are protruded from the cantilever plates.

10. A portable electronic device, comprising:
a battery housing member, the battery housing member including a first sidewall and a second sidewall opposite to the second sidewall;
a battery cover, the battery cover including two opposite sliding plates; and
a guiding mechanism, the guiding mechanism including two first guiding grooves respectively defined in the first sidewall and the second sidewall of the battery housing member, and two second guiding poles protruding from sliding plates of the battery cover, the second guiding poles being slidably accommodated in the second guiding grooves such that the battery cover is slidably mounted to the battery housing member.

11. The portable electronic device as claimed in claim 10, wherein the guiding mechanism further includes two first guiding poles, a second guiding groove defined therein, said two first guiding poles respectively protrude from the first sidewall and the second sidewall of the battery housing member, and said two second guiding grooves are respectively defined in the sliding plates of the battery cover, the first guiding poles are slidably accommodated in the second guiding grooves

12. The portable electronic device as claimed in claim 11, wherein each first guiding pole has a first latching portion formed thereon, each sliding plate has a second latching portion formed on an inner surface in the second guiding groove, the first latching portions are latched with the second latching portion to firmly mount the battery cover to the battery housing member.

13. The portable electronic device as claimed in claim 12, wherein each first latching portion is a slot defined in the first guiding pole, each second latching portion is a protrusion protruding from the inner surface in the second guiding groove, the protrusions are accommodated in the slots to firmly mount the battery cover to the battery housing member.

14. The portable electronic device as claimed in claim 11, wherein the battery housing assembly further includes a third sidewall connecting the first sidewall with the second sidewall, the first guiding poles are located between the first third sidewall and the first guiding grooves.

15. The portable electronic device as claimed in claim 14, wherein the battery housing member further includes a fourth sidewall, the first guiding grooves extend from the third sidewall to the fourth sidewall.

16. The portable electronic device as claimed in claim 15, wherein the extending path of each first guiding groove is arcuate.

17. The portable electronic device as claimed in claim 16, wherein the second guiding grooves have the same shape and size as the first guiding grooves.

18. The portable electronic device as claimed in claim 11, wherein the battery cover further includes a cover plate, the sliding plates protrude from two opposite edge of the cover plate.

19. The portable electronic device as claimed in claim 18, wherein the sliding plates extend outwardly one end of the cover plate, so two opposite cantilever plates are formed on battery cover, the second guiding poles are protruded from the cantilever plates.
